(19) United States
(12) Patent Application Publication
(10) Pub. No.: US 2015/0018205 A1
(43) Pub. Date: Jan. 15, 2015

(54) Optimum Loading of Copper-Manganese Spinel on TWC Performance and Stability of ZPGM Catalyst Systems

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(21) Appl. No.: 14/308,401

(22) Filed: Jun. 18, 2014

Related U.S. Application Data
(63) Continuation-in-part of application No. 14/251,186, filed on Apr. 11, 2014.
Application No. 14/251,186 is a continuation-in-part of application No. 13/941,015, filed on Jul. 12, 2013.

(51) Int. Cl. B01J 23/889; B01D 53/94

(52) U.S. Cl. CPC B01J 23/8892; B01D 53/945
USPC 502/324

(57) ABSTRACT

Influence of a plurality of base metal loadings on TWC performance and thermal stability of ZPGM catalysts for TWC applications is disclosed. ZPGM catalyst samples are prepared and configured with washcoat on ceramic substrate, overcoat including doped Zirconia support oxide, and impregnation layer of Cu—Mn spinel with different base metal loadings. Testing of ZPGM catalyst samples including variations of base metal loadings is developed under isothermal steady state sweep test condition for fresh and aged ZPGM catalysts to evaluate the influence of variations of base metal loadings on TWC performance specially NOₓ conversions and level of stability of NOx conversion. As a result disclosed ZPGM catalyst systems with an optimum base metal loadings exhibit high and stable NOx conversion which is suitable for under floor TWC application.

### CROSS-REFERENCE TO RELATED APPLICATIONS

This application is a continuation-in-part of U.S. patent application Ser. No. 14/251,186, filed May 20, 2014, titled Systems and Methods for Using Copper-Manganese Spinel As Active Phase For Diesel Oxidation Applications, and U.S. patent application Ser. No. 13/941,015, filed Jul. 12, 2013, titled Optimization of Zero-PGM Washcoat and Overcoat Loadings on Metallic Substrate, the entireties of which are incorporated by reference herein.

### BACKGROUND

1. Field of the Disclosure

This disclosure relates generally to catalyst materials, and more particularly to the effect of Cu—Mn loadings on three-way catalyst (TWC) performance and thermal stability of Zero-PGM (ZPGM) catalyst systems.

2. Background Information

The behavior of catalyst systems may be controlled by the properties of the slurry characteristics of materials used in appropriate loadings. Different catalyst properties can be achieved in terms of base metal loadings such that a coating of sufficient loading may provide improved active sites for catalytic performance.

One of the major problems with manufacturing of catalyst systems may be achieving the appropriate metal loading for catalytic performance. The metal loadings employed may fail to provide catalyst layers capable of producing appropriate TWC performance. Pluralities of factors which can affect performance are suitable formulation and loading of ZPGM materials, and adequate loading of washcoat and overcoat, among others.

Current TWC systems significantly increase the efficiency of conversion of pollutants and, thus, aid in meeting emission standards for automobiles and other vehicles. In order to achieve an efficient three-way conversion of the toxic components in the exhaust gas, conventional TWC includes large quantities of PGM material, such as platinum, palladium, and rhodium, among others, dispersed on suitable oxide carriers. Because catalysts including PGM materials provide a very high activity for the conversion of NOₓ, they are typically considered to be essential component of TWC systems.

Recent environmental concerns for a catalyst's high performance have increased the focus on the operation of a TWC at the end of its lifetime. Catalytic materials used in TWC applications have also changed, and the new materials have to be thermally stable under the fluctuating exhaust gas conditions. The attainment of the requirements regarding the techniques to monitor the degree of the catalyst's deterioration/deactivation demands highly active and thermally stable catalysts. As NO emission standards tighten and PGMs become scarce with small market circulation volume, constant fluctuations in price, and constant risk to stable supply, among others, there is an increasing need for new TWC catalyst compositions which may not require PGM and may be able to maintain efficient TWC of exhaust byproducts. There also remains a need for methods of producing such TWC catalyst formulations using the appropriate metal loadings of non-PGM material.

According to the foregoing, there may be a need to provide catalytic properties which may significantly depend on optimum metal loadings to obtain, under some conditions, high dispersion metal components systems for PGM-free catalyst systems which may be manufactured cost-effectively, such that TWC performance of ZPGM catalyst systems may be improved by realizing suitable PGM-free catalytic layers.

### SUMMARY

For catalysts, in a highly dispersed and active form aiming at improving catalyst activity, a more effective utilization of the PGM-free catalyst materials may be achieved when expressed as a function of base metal loadings. A plurality of coating process techniques may be employed for the incorporation of catalytically active species onto support oxide materials, which are influential to the coating properties. A process for coating of sufficient loading may provide improved active sites for catalytic performance. In present disclosure, impregnation technique may be employed to incorporate active catalyst material and to describe important factors which may derive from variations of base metal loadings and their influence on the activity, selectivity, and durability of the catalyst system.

According to embodiments in present disclosure, a ZPGM catalyst system may include at least a substrate, a washcoat layer, an overcoat layer and an impregnation layer. A plurality of ZPGM catalyst systems may be configured to include an alumina-based washcoat layer coated on a suitable ceramic substrate, an overcoat layer of support oxide material, such as doped ZrO₂, and an impregnation layer including Cu—Mn spinel with a plurality of base metal loadings.

According to embodiments in present disclosure, impregnation technique may be used for deposition of CuₓMn₃₋ₓO₄ spinel of varied loadings on an overcoat layer of support oxide material, such as doped ZrO₂.

Subsequently, fresh and aged ZPGM catalyst samples may undergo testing to measure/analyze influence of variations of base metal loadings on TWC performance and thermal stability of ZPGM and find out the optimum loading of Cu—Mn spinel.

The NO/CO cross over R-value of prepared fresh and aged ZPGM catalyst samples, per variations of base metal loadings employed in present disclosure, may be determined and compared by performing isothermal steady state sweep test, which may be carried out at a selected inlet temperature using an 11-point R-value from rich condition to lean condition, at a plurality of space velocities. Results from isothermal steady state test may be compared under lean condition and rich condition close to stoichiometric condition to show the influence of base metal loadings on TWC performance.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows configuration for disclosed ZPGM catalyst system which includes an alumina-based washcoat on substrate, an overcoat with doped ZrO₂, and an impregnation layer including Cu—Mn spinel, according to an embodiment.

FIG. 2 shows NO conversion for fresh samples of ZPGM catalyst system Type 1, ZPGM catalyst system Type 2, ZPGM catalyst system Type 3, and ZPGM catalyst system Type 4, from R-value about 1.4 (rich condition) to about 0.80 (lean condition), under isothermal steady state sweep condition, at inlet temperature of about 450° C. and SV of about 40,000 h⁻¹, according to an embodiment.

FIG. 3 shows NO conversion for fuel cut aged (at 800° C. during about 20 hours) samples of ZPGM catalyst system Type 1, ZPGM catalyst system Type 2, ZPGM catalyst system Type 3, and ZPGM catalyst system Type 4, from about 1.40 (rich condition) to about 0.80 (lean condition), under isothermal steady state sweep condition, at inlet temperature of about 450° C. and SV of about 40,000 h⁻¹, according to an embodiment.

FIG. 4 shows NO conversion for XRFA aged (at 850° C. during about 20 hours) samples of ZPGM catalyst system Type 1, ZPGM catalyst system Type 2, ZPGM catalyst system Type 3, and ZPGM catalyst system Type 4, from about 2.0 (rich condition) to about 0.80 (lean condition), under isothermal steady state sweep condition, at inlet temperature of about 450° C. and SV of about 40,000 h⁻¹, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Platinum group Metal (PGM)” refers to platinum, palladium, ruthenium, iridium, osmium, and rhodium.

“Zero platinum group (ZPGM) catalyst” refers to a catalyst completely or substantially free of platinum group metals.

“Catalyst” refers to one or more materials that may be of use in the conversion of one or more other materials.

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat or impregnation layer.

“Milling” refers to the operation of breaking a solid material into a desired grain or particle size.

“Impregnation” refers to the process of imbuing or saturating a solid layer with a liquid compound or the diffusion of some element through a medium or substance.

“Calcination” refers to a thermal treatment process applied to solid materials, in presence of air, to bring about a thermal decomposition, phase transition, or removal of a volatile fraction at temperatures below the melting point of the solid materials.

“Spinel” refers to any of various mineral oxides of magnesium, iron, zinc, or manganese in combination with aluminum, chromium, copper or iron with AB₂O₄ structure.

“Conversion” refers to the chemical alteration of at least one material into one or more other materials.

“R-value” refers to the number obtained by dividing the reducing potential by the oxidizing potential of materials in a catalyst.

“Rich condition” refers to exhaust gas condition with an R-value above 1.

“Lean condition” refers to exhaust gas condition with an R-value below 1.

“Air/Fuel ratio” or A/F ratio” refers to the weight of air divided by the weight of fuel.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

### DESCRIPTION OF THE DRAWINGS

The present disclosure may provide material compositions including Cu—Mn spinel on support oxide with different metal loadings to develop suitable catalytic layers capable of providing high chemical reactivity and thermal stability for ZPGM catalysts. The diversified aspects that may be treated in present disclosure may show improvements in the process for overall catalytic conversion capacity or recombination rates for a plurality of ZPGM catalysts which may be suitable for TWC applications.

Catalyst Material Composition, Preparation, and Configuration

As catalyst performance parameters may be translated into the physical catalyst structure, different base metal loadings may be used to achieve desired coating properties and effective level of catalytic performance.

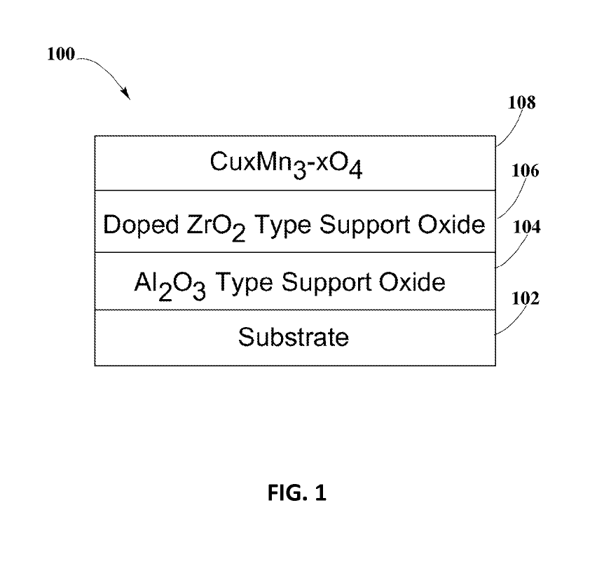

FIG. 1 shows a configuration for ZPGM catalyst system 100, according to an embodiment.

As shown in FIG. 1, ZPGM catalyst system 100 may include at least a substrate 102, a washcoat 104, an overcoat 106, and an impregnation layer 108, where washcoat 104 may include alumina type support oxide, overcoat 106 may include doped ZrO₂ support oxide, and impregnation layer 108 may include Cu—Mn spinel, CuₓMn₃₋ₓO₄.

In order to manufacture disclosed ZPGM catalyst system 100, the preparation of washcoat 104 may begin by milling alumina (Al₂O₃) to make aqueous slurry. Then, the resulting slurry may be coated as washcoat 104 on substrate 102, dried and fired at about 550° C. for about 4 hours.

The preparation of overcoat 106 may begin by milling doped ZrO2 support oxide such as Praseodymium-Zirconium support oxide (ZrO₂—Pr₆O₁₁) with water to make aqueous slurry. Then, the resulting slurry may be coated as overcoat 106 on washcoat 104, dried and fired at about 550° C. for about 4 hours.

The impregnation layer 108 may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, according to formulation CuₓMn₃₋ₓO₄, in which X may take value of 0.05 to 1.5. Subsequently, Cu—Mn solution may be impregnated to overcoat 106, then fired (calcined) at a temperature within a range of about 550° C. to about 650° C., preferably at about 600° C. for about 5 hours.

Coating properties, catalytic performance and thermal stability, that may derive from different base metal loadings within disclosed ZPGM catalyst systems, may be verified under isothermal steady state sweep condition.

Isothermal Steady State Sweep Test Procedure

The isothermal steady state sweep test may be carried out employing a flow reactor at inlet temperature of about 450° C., and testing a gas stream at 11-point R-values from about 2.00 (rich condition) to about 0.80 (lean condition) to measure the CO, NO, and HC conversions.

The space velocity (SV) in the isothermal steady state sweep test may be adjusted at about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NOₓ, about 2,000 ppm of H₂, about 10% of CO₂, and about 10% of H₂O. The quantity of O₂ in the gas mix may be varied to adjust Air/Fuel (A/F) ratio within the range of R-values to test the gas stream.

The following examples are intended to illustrate the scope of the disclosure. It is to be understood that other procedures known to those skilled in the art may alternatively be used.

### Examples

### Example #1

### ZPGM Catalyst System Type 1—Ratio of Base Metal Loading is “X”

Example #1 may illustrate composition of ZPGM catalyst system 100, with a ratio of base metal loading of “X”, where copper loading within impregnation layer 108, may be about 11.8% by weight and manganese loading within impregnation layer 108 may be about 20.4% by weight.

In order to manufacture disclosed ZPGM catalyst system Type 1, the preparation of washcoat 104 may begin by milling alumina (Al₂O₃) to make aqueous slurry. Then, the resulting slurry may be coated as washcoat 104 on substrate 102, dried and fired at about 550° C. for about 4 hours. Total loading of washcoat 104 material may be 120 g/L. The preparation of overcoat 106 may begin by milling Praseodymium-Zirconium support oxide (ZrO₂—Pr₆O₁₁) with water to make aqueous slurry. Then, the resulting slurry may be coated as overcoat 106 on washcoat 104, dried and fired at about 550° C. for about 4 hours. Total loading of overcoat 106 material may be 120 g/L.

The impregnation layer 108 may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, according to formulation CuₓMn₃₋ₓO₄, in which X may take value of 1.0, and where copper loading may be about 11.8% by weight and manganese loading may be about 20.4% by weight. Subsequently, Cu—Mn solution may be impregnated to overcoat 106, then fired (calcined) at a temperature within a range of about 550° C. to about 650° C., preferably at about 600° C. for about 5 hours.

### Example #2

### ZPGM Catalyst System Type 2—Ratio of Base Metal Loading is “2×”

Example #2 may illustrate composition of ZPGM catalyst system 100, with a ratio of base metal loading of “X”, where copper loading within impregnation layer 108, may be about 23.6% by weight and manganese loading within impregnation layer 108 may be about 40.8% by weight.

In order to manufacture disclosed ZPGM catalyst system 100, the preparation of washcoat 104 may begin by milling alumina (Al₂O₃) to make aqueous slurry. Then, the resulting slurry may be coated as washcoat 104 on substrate 102, dried and fired at about 550° C. for about 4 hours. Total loading of washcoat 104 material may be 120 g/L. The preparation of overcoat 106 may begin by milling Praseodymium-Zirconium support oxide (ZrO₂—Pr₆O₁₁) with water to make aqueous slurry. Then, the resulting slurry may be coated as overcoat 106 on washcoat 104, dried and fired at about 550° C. for about 4 hours. Total loading of overcoat 106 material may be 120 g/L.

The impregnation layer 108 may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, according to formulation CuₓMn₃₋ₓO₄, in which X may take value of 1.0, and where copper loading may be about 23.6% by weight and manganese loading may be about 40.8% by weight. Subsequently, Cu—Mn solution may be impregnated to overcoat 106, then fired (calcined) at a temperature within a range of about 550° C. to about 650° C., preferably at about 600° C. for about 5 hours.

### Example #3

### ZPGM Catalyst System Type 3—Ratio of Base Metal Loading is “3×”

Example #1 may illustrate composition of ZPGM catalyst system 100, with a ratio of base metal loading of “X”, where copper loading within impregnation layer 108, may be about 35.4% by weight and manganese loading within impregnation layer 108 may be about 61.2% by weight.

In order to manufacture disclosed ZPGM catalyst system 100, the preparation of washcoat 104 may begin by milling alumina (Al₂O₃) to make aqueous slurry. Then, the resulting slurry may be coated as washcoat 104 on substrate 102, dried and fired at about 550° C. for about 4 hours. Total loading of washcoat 104 material may be 120 g/L. The preparation of overcoat 106 may begin by milling Praseodymium-Zirconium support oxide (ZrO₂—Pr₆O₁₁) with water to make aqueous slurry. Then, the resulting slurry may be coated as overcoat 106 on washcoat 104, dried and fired at about 550° C. for about 4 hours. Total loading of overcoat 106 material may be 120 g/L.

The impregnation layer 108 may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, according to formulation CuₓMn₃₋ₓO₄, in which X may take value of 1.0, and where copper loading may be about 35.4% by weight and manganese loading may be about 61.2% by weight. Subsequently, Cu—Mn nitrate solution may be mixed for about 1 hour to about 2 hours. Resulting Cu—Mn solution may be impregnated to overcoat 106, then fired (calcined) at a temperature within a range of about 550° C. to about 650° C., preferably at about 600° C. for about 5 hours.

### Example #4

### ZPGM Catalyst System Type 4—Ratio of Base Metal Loading is “5×”

Example #1 may illustrate composition of ZPGM catalyst system 100, with a ratio of base metal loading of “X”, where copper loading within impregnation layer 108, may be about 59.0% by weight and manganese loading within impregnation layer 108 may be about 102% by weight.

In order to manufacture disclosed ZPGM catalyst system 100, the preparation of washcoat 104 may begin by milling alumina (Al₂O₃) to make aqueous slurry. Then, the resulting slurry may be coated as washcoat 104 on substrate 102, dried and fired at about 550° C. for about 4 hours. Total loading of washcoat 104 material may be 120 g/L. The preparation of overcoat 106 may begin by milling Praseodymium-Zirconium support oxide (ZrO₂—Pr₆O₁₁) with water to make aqueous slurry. Then, the resulting slurry may be coated as overcoat 106 on washcoat 104, dried and fired at about 550° C. for about 4 hours. Total loading of overcoat 106 material may be 120 g/L.

The impregnation layer 108 may be prepared by mixing the appropriate amount of Mn nitrate solution (Mn(NO₃)₂) and Cu nitrate solution (CuNO₃) with water to make solution at appropriate molar ratio for Cu_{1.0}Mn_{2.0}O₄, according to formulation CuₓMn₃₋ₓO₄, in which X may take value of 1.0, and where copper loading may be about 59.0% by weight and manganese loading may be about 102% by weight. Subsequently, Cu—Mn nitrate solution may be mixed for about 1 hour to about 2 hours. Resulting Cu—Mn solution may be impregnated to overcoat 106, then fired (calcined) at a temperature within a range of about 550° C. to about 650° C., preferably at about 600° C. for about 5 hours.

Isothermal Steady State Sweep Test for ZPGM Catalyst Systems

The performance of prepared fresh and aged ZPGM catalyst samples per base metal loadings, ZPGM catalyst system Type 1, ZPGM catalyst system Type 2, ZPGM catalyst system Type 3, and ZPGM catalyst system Type 4 may be determined by performing isothermal steady state sweep test at inlet temperature of about 450° C., and testing a gas stream at 11-point R-values from about 2.00 (rich condition) to about 0.80 (lean condition) to measure the CO, NO, and HC conversions.

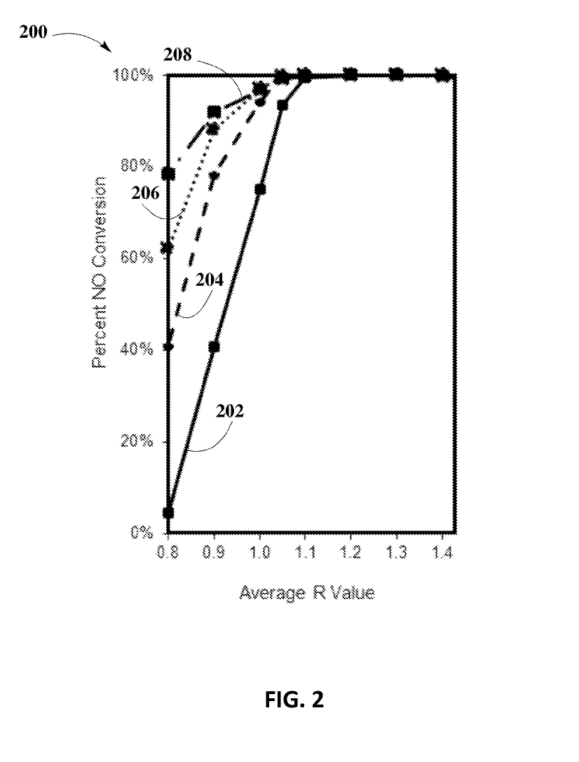

FIG. 2 shows catalyst performance 200 for fresh samples of ZPGM catalyst system Type 1, ZPGM catalyst system Type 2, ZPGM catalyst system Type 3, and ZPGM catalyst system Type 4, from about R-value=1.4 (rich condition) to about 0.80 (lean condition), under isothermal steady state sweep condition, at inlet temperature of about 450° C. and SV of about 40,000 h⁻¹, according to an embodiment.

In FIG. 2, NO conversion curve 202, NO conversion curve 204, NO conversion curve 206, and NO conversion curve 208 show NO conversion results for ZPGM catalyst system Type 1, ZPGM catalyst system Type 2, ZPGM catalyst system Type 3, and ZPGM catalyst system Type 4, respectively.

As may be observed in FIG. 2, results from isothermal steady state sweep test for fresh ZPGM catalyst samples prepared with different base metal loadings reveal a significant high activity, specially under lean condition. NO conversion increased by increasing the loading of base metal from ZPGM catalyst system Type 1 to ZPGM catalyst system Type 4. ZPGM catalyst system Type 3 and ZPGM catalyst system Type 4 exhibit higher level of lean NOx conversion compared to ZPGM catalyst system Type 1, and ZPGM catalyst system Type 2. For example, at an R-value of 0.9 (lean condition), ZPGM catalyst system Type 3 and ZPGM catalyst system Type 4 exhibit NOx conversion of about 87.97% and 91.82%, respectively, while ZPGM catalyst system Type 1 and ZPGM catalyst system Type 2 exhibit NO conversion of about 40.72% and 78.36%, respectively. By considering CO conversion, the NO/CO cross over R-value, where NO and CO conversions are equal, for ZPGM catalyst system Type 2, and ZPGM catalyst system Type 3, takes place at the specific R-value of 1.05 (very close to stoichiometric condition). Moreover, NO/CO cross over for ZPGM catalyst system Type 1 takes place at the specific R-value of 1.10, and NO/CO cross over for ZPGM catalyst system Type 4 takes place at the specific R-value of 1.09 (close to rich condition).

Result of isothermal steady state sweep test show that all disclosed fresh ZPGM catalyst systems 100 exhibit high level of NOx conversion of about 99.99% at R value of 1.0 (stoichiometric condition) and significant lean NOx conversion, which increased by increasing the loading of Cu—Mn spinel in impregnation layer.

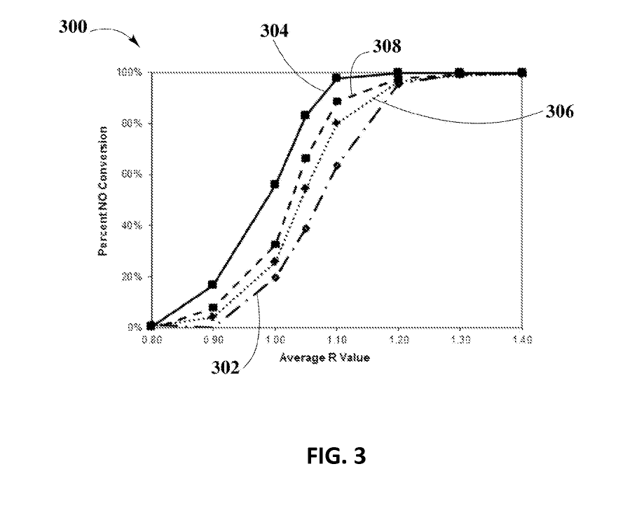

FIG. 3 shows catalyst performance 300 for fuel cut aged (at 800° C. during about 20 hours) samples of ZPGM catalyst system Type 1, ZPGM catalyst system Type 2, ZPGM catalyst system Type 3, and ZPGM catalyst system Type 4, from R-value about 1.4 (rich condition) to about 0.80 (lean condition), under isothermal steady state sweep condition, at inlet temperature of about 450° C. and SV of about 40,000 h⁻¹, according to an embodiment.

In FIG. 3, NO conversion curve 302, NO conversion curve 304, NO conversion curve 306, and NO conversion curve 308 show isothermal steady state sweep test results for ZPGM catalyst system Type 1, ZPGM catalyst system Type 2, ZPGM catalyst system Type 3, and ZPGM catalyst system Type 4, respectively.

As shown in FIG. 3, Results from isothermal steady state sweep test for aged ZPGM catalyst samples prepared with different base metal loadings reveal a significant high activity after aging at 800° C. Among them, ZPGM catalyst system Type 2 shows higher NO conversion. For example, at an R value of 1.1, conversion curve 302 shows that NOx conversion for ZPGM catalyst system Type 1 is of about 63.53%, for ZPGM catalyst system Type 2 is of about 97.84%, for ZPGM catalyst system Type 3 is of about 80.15%, and for ZPGM catalyst system Type 4 is of about 88.63%.

These results show that at an R value of 1.1 (rich condition close to stoichiometric condition) ZPGM catalyst system Type 2 with Cu—Mn loading of 2× exhibit higher NOx conversion level compared to the other disclosed ZPGM catalyst systems that include different base metal loadings, which shows higher stability of ZPGM catalyst system Type 2 after 800° C. aging. By considering CO conversion, the NO/CO cross over R-value, where NO and CO conversions are equal, for ZPGM catalyst system Type 2 take place at the specific R-value of 1.16 which was about 1.05 at fresh condition as shown in FIG. 2.

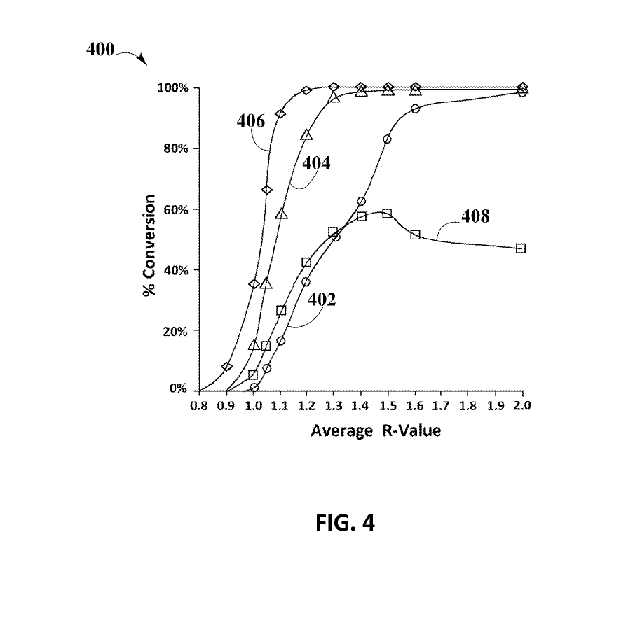

FIG. 4 shows catalyst performance 400 for XRFA aged (at 850° C., for about 20 hours) samples of ZPGM catalyst system Type 1, ZPGM catalyst system Type 2, ZPGM catalyst system Type 3, and ZPGM catalyst system Type 4, from R-value about 2.0 (rich condition) to about 0.80 (lean condition), under isothermal steady state sweep condition, at inlet temperature of about 450° C. and SV of about 40,000 h⁻¹, according to an embodiment.

In FIG. 4, NO conversion curve 402, NO conversion curve 404, NO conversion curve 406, and NO conversion curve 408 show isothermal steady state sweep test results for ZPGM catalyst system Type 1, ZPGM catalyst system Type 2, ZPGM catalyst system Type 3, and ZPGM catalyst system Type 4, respectively.

As shown in FIG. 4, Results from isothermal steady state sweep test for aged ZPGM catalyst samples prepared with different base metal loadings reveal a significant high activity after aging at 850° C. Results shows ZPGM catalyst system Type 1 to ZPGM catalyst system Type 4 show different behavior after aging under XRFA condition at 850° C., 20 hrs compared to 800° C. The NO conversion of ZPGM samples after aging at 850° C. increased by increasing the base metal loading from 1× to 3× and then significantly decreased by further increasing the loading of base metal to 5×. ZPGM catalyst system Type 3 with Cu—Mn loading of 3× shows higher NO conversion indicating higher thermal stability. For example, at an R value of 1.1, NO conversion curve 402 shows that NOx conversion for ZPGM catalyst system Type 1 is of about 16.8%, for ZPGM catalyst system Type 2 is of about 58.5%, for ZPGM catalyst system Type 3 is of about 91.3%, and for ZPGM catalyst system Type 4 is of about 26.3%. The comparison of NO conversion of ZPGM catalyst system Type 3 after aging at 800° C. and 850° C. shows even improvement of NO conversion after aging at higher temperature.

Results from isothermal steady state sweep test show that ZPGM catalyst systems 100 including Cu—Mn spinel within impregnation layers exhibit high catalytic activity under fresh samples and the lean NOx conversion improved by increasing the total loading of Cu—Mn spinel from 1× to 5×, this is very helpful in reducing fuel consumption. The results from aging samples shows ZPGM catalyst system Type 3 with total Cu—Mn spinel loading of 3× contains suitable base metal loading and exhibit a high level of NOx conversion after aging under fuel cut condition at 850° C.; indicating thermal stability of ZPGM catalyst system Type 3 at 850° C. aging which is suitable aging temperature for under floor catalyst application.

According to principles in present disclosure, use of different base metal loadings in coating processes, in impregnation layers, may bring about different effects on TWC performance and thermal stability of ZPGM as may be observed from the results of the disclosed base metal loadings in example #1, example #2, example #3, and example #4. The introduction of more rigorous regulations are forcing catalyst manufacturers to device new technologies in order to ensure a high thermally stable catalytic activity and effect of coating processes on TWC performance may need to be oriented toward continuously enhancing the level of conversion of toxic emissions.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

1. A method for optimizing a catalytic system, comprising:
providing a catalyst system, comprising:
a substrate;
a washcoat suitable for deposition on the substrate, comprising alumina;
an overcoat suitable for deposition on the substrate, the overcoat comprising at least one support oxide material comprising ZrO₂; and
an impregnation layer suitable for deposition on the substrate, comprising copper-manganese spinel having a compositional ratio of X, wherein X comprises between 10 and 15 percent by weight copper and 15 to 25 percent by weight of manganese; and
adjusting the ratio of copper to manganese to improve NOₓ conversion.

2. The method according to claim 1, wherein the copper to manganese ratio is about 11.8% to about 20.4%.

3. The method according to claim 1, wherein the copper-manganese spinel has the general formula of CuₓMn₃₋ₓO₄.

4. The method according to claim 1, wherein the catalytic system is hydrothermal aging at greater than 800° C.

5. The method according to claim 4, wherein the hydrothermal aging lasts for about 2 to about 6 hours.

6. The method according to claim 4, wherein the hydrothermal aging lasts for about 4 hours.

7. The method according to claim 1, wherein the overcoat further comprises at least one oxygen storage material.

8. The method according to claim 1, wherein X is selected from the range of 1× to 5×.

9. The method according to claim 1, wherein the NO/CO cross over R-value is 1.05.

10. The method according to claim 1, wherein the NO conversion is greater than 90% at an R-value of 1.0.

11. The method according to claim 1, wherein the NO conversion is greater than 99% at an R-value of 1.0.

12. The method according to claim 1, wherein the CO conversion is greater than 90% at an R-value of 1.0.

13. The method according to claim 1, wherein the CO conversion is greater than 99% at an R-value of 1.0.

14. The method according to claim 4, wherein the NO/CO cross over value R-value is 1.16.

15. The method of claim 1, wherein the catalyst system is hydrothermal aged at 800° C. for greater than 15 hours.

16. The method of claim 15, wherein X is 3×.

17. The method of claim 1, wherein the conversion of NOₓ increases as the value of X increases in the range of 1× to 5×.
